(19) United States
(12) Patent Application Publication
(10) Pub. No.: US 2025/0381788 A1
(43) Pub. Date: Dec. 18, 2025

(54) PRINTER

(71) Applicant: Toshiba Tec Kabushiki Kaisha, Tokyo (JP)

(72) Inventor: Teruyuki OCHIAI, Singapore (SG)

(73) Assignee: Toshiba Tec Kabushiki Kaisha, Tokyo (JP)

(21) Appl. No.: 19/054,478

(22) Filed: Feb. 14, 2025

(30) Foreign Application Priority Data
Jun. 18, 2024 (JP) 2024-098147

(51) Int. Cl. B41J 25/308; B41J 2/325; B41J 3/407; B41J 11/04; B41J 29/02; B41J 29/13

(52) U.S. Cl. CPC B41J 25/3088; B41J 2/325; B41J 3/4075; B41J 11/04; B41J 29/02; B41J 29/13

(57) ABSTRACT

A printer includes a first casing including a first engaged part and a second casing including a second engaged part. The printer also includes an engagement position adjustment mechanism and an engagement position indicator. The engagement position adjustment mechanism is configured to adjust a first position of at least one of the first engaged part and the second engaged part to a second position, where the first engaged part and the second engaged part engage with each other at the second position. The engagement position indicator is configured to indicate the second position of the at least one the first engaged part and the second engaged part.

### CROSS-REFERENCE TO RELATED APPLICATION

This application is based upon and claims the benefit of priority from Japanese Patent Application No. 2024-098147, filed on Jun. 18, 2024, the entire contents of which are incorporated herein by reference.

### FIELD

Embodiments described herein relate generally to a printer.

### BACKGROUND

According to the related art, a printer that prints on a print target medium, using a thermal head, is provided. The printing method of the printer of this type is a thermal transfer method in which the ink of an ink ribbon is melted by the heat of the thermal head and fixed to a sheet, or a thermal method in which a sheet containing a color developer is heated by the thermal head to develop color. In both printing methods, since printing is performed with the thermal head pressed against the print target medium on a platen roller, the pressure of the thermal head applied to the print target medium affects the quality of printing. Specifically, if the pressure applied to the print target medium is uneven between the left and right in the longitudinal direction of the thermal head, this may cause fading of the print or wrinkling of the ink ribbon.

In a printer in which a thermal head is arranged in an upper part of a casing and in which a platen roller is arranged in a lower part of the casing, the pressure of the thermal head is determined based on a position where an engaging part and an engaged part engage with each other to fix the position where the upper part and the lower part of the casing are closed. For example, in a printer having a hook as the engaging part in the upper part of the casing and a pin as the engaged part in the lower part of the casing, the pressure of the thermal head decreases as the positions of the hook and the pin become closer to each other, and the pressure of the thermal head increases as the positions of the hook and the pin become farther from each other. The position of the pin can be adjusted in an up-down direction. The pressure of the thermal head is adjusted by adjusting the position of the pin.

It is preferable to be able to check the position of the moved pin.

DESCRIPTION OF THE DRAWINGS

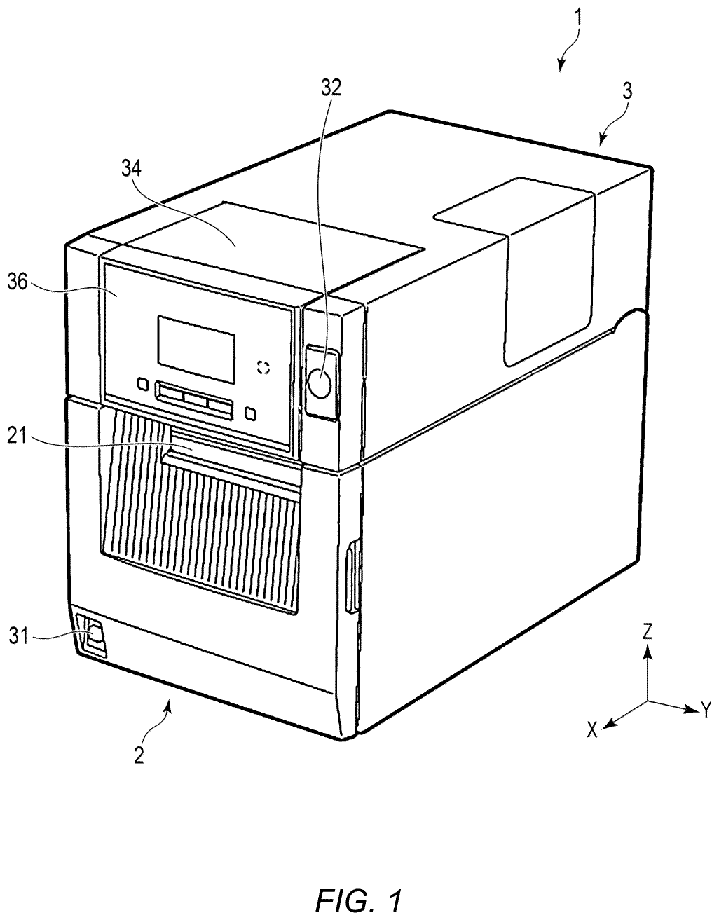

FIG. 1 is a perspective view showing an external appearance of a thermal printer according to an embodiment.

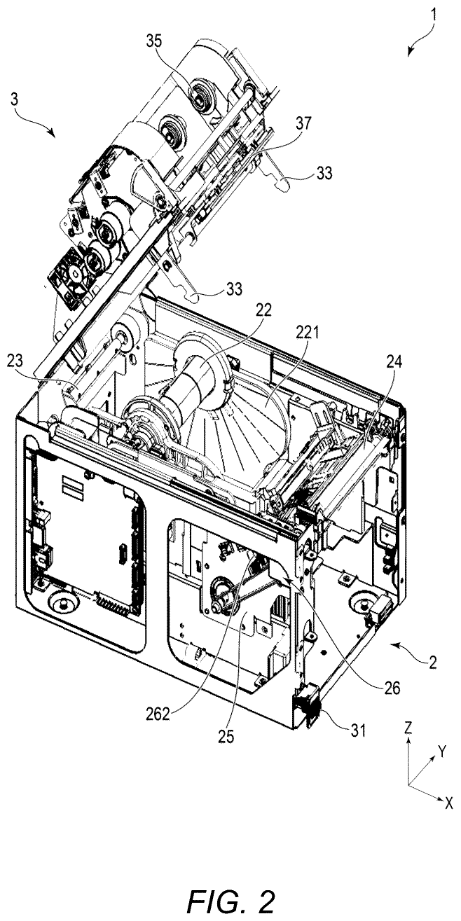

FIG. 2 is a perspective view showing a state where a cover is removed and in an open state.

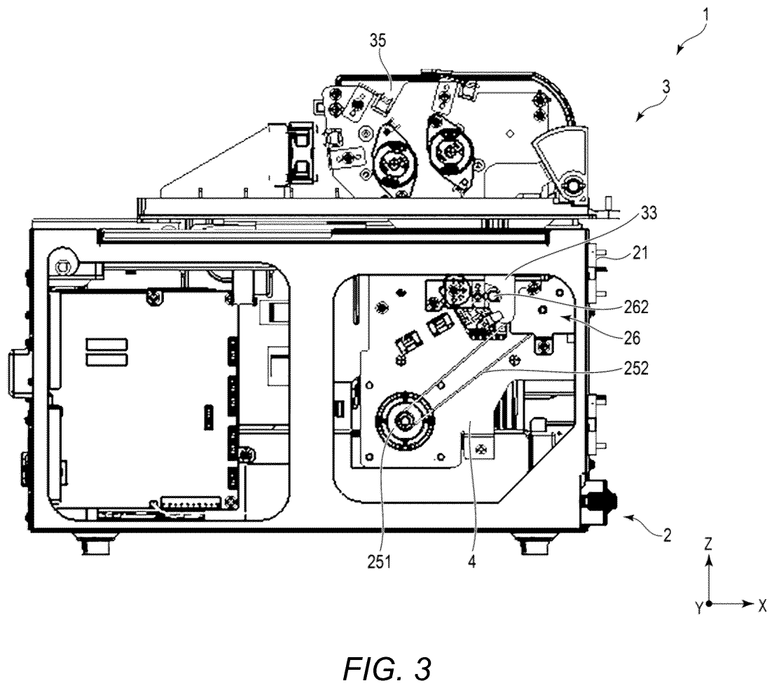

FIG. 3 is a side view showing the state where the cover is removed and in a closed state.

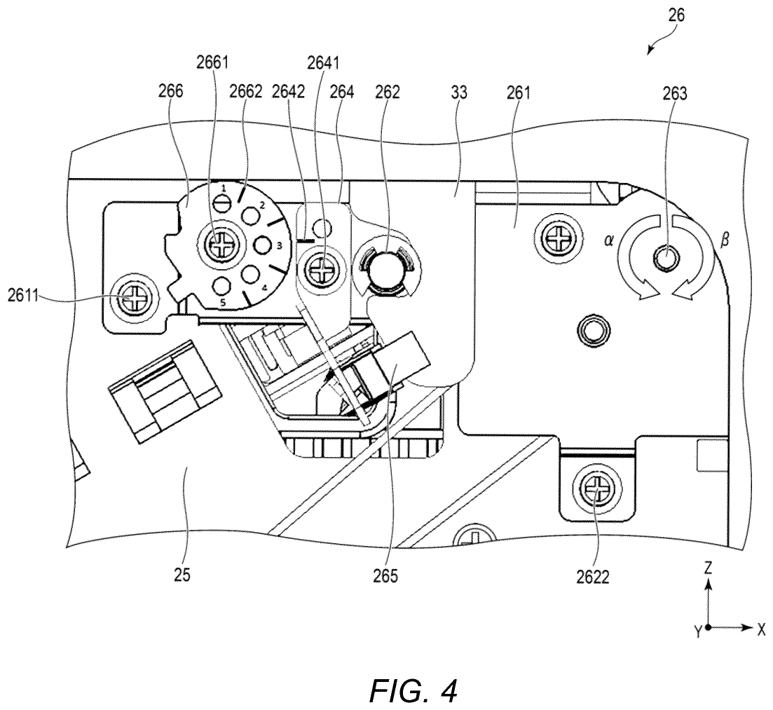

FIG. 4 is a detailed, cross-sectional view showing a state where a hook and a pin are engaged with each other.

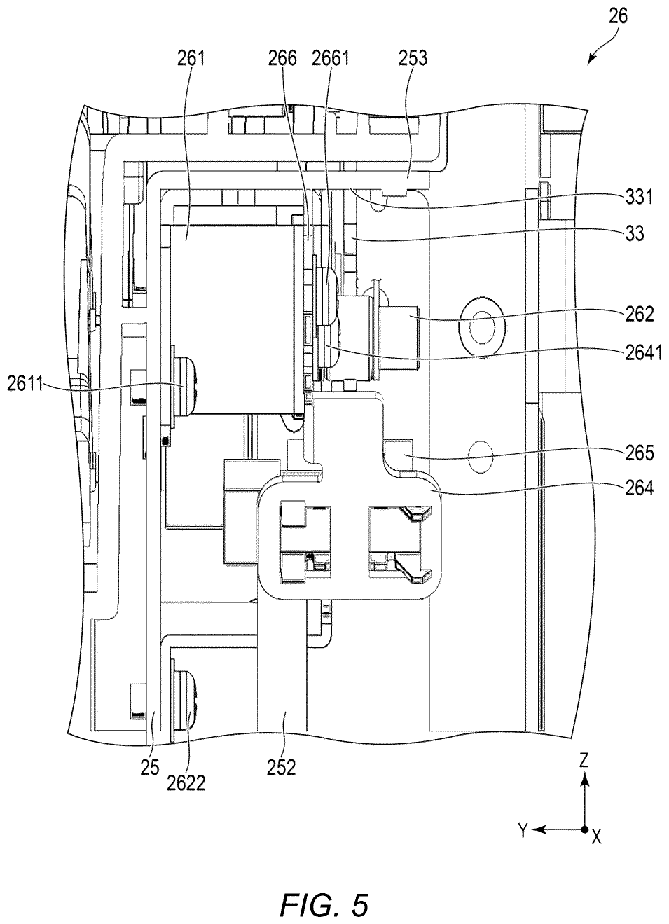

FIG. 5 is a detailed, cross-sectional view showing the positional relationship between an engagement position adjustment plate and a motor frame.

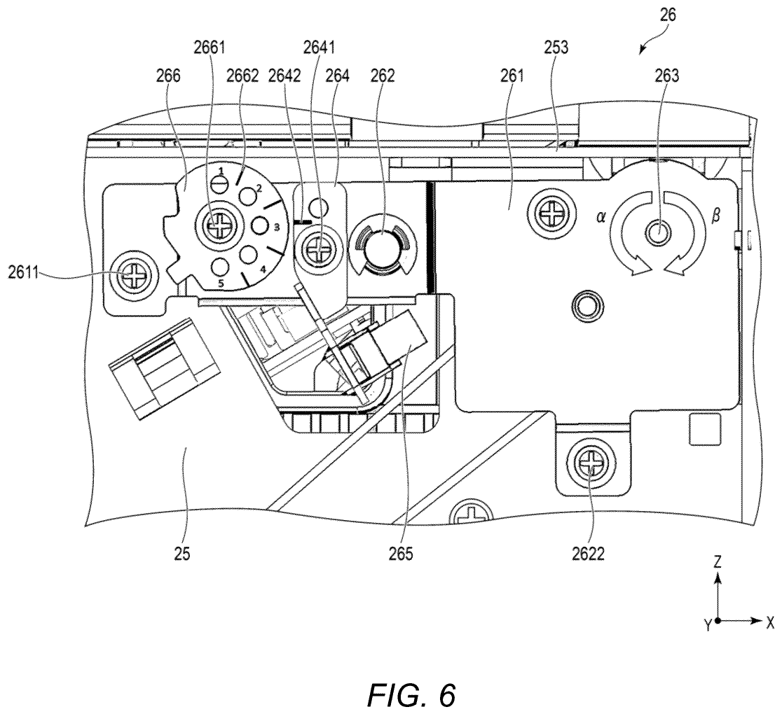

FIG. 6 is a detailed, cross-sectional view showing the positional relationship between an eccentric plate and the motor frame.

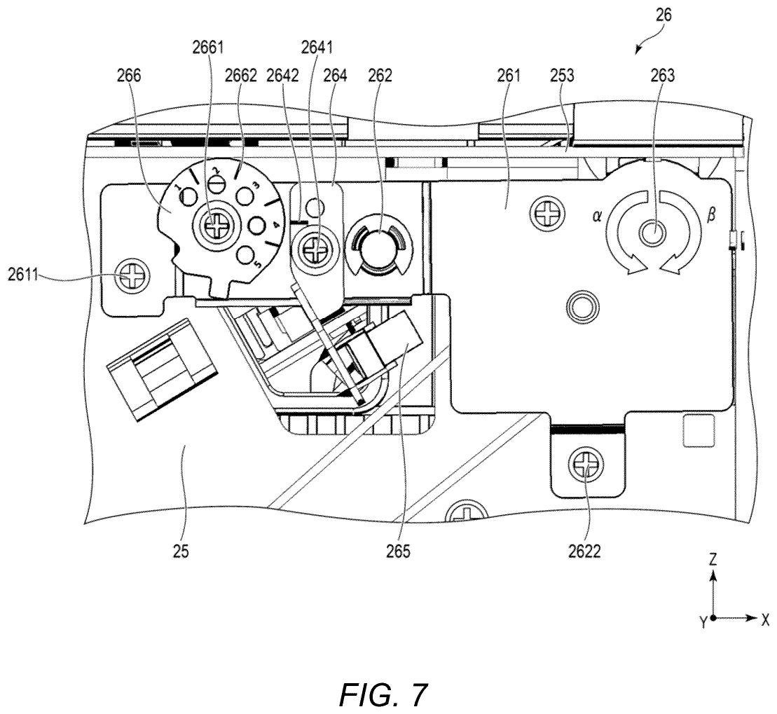

FIG. 7 is a detailed, cross-sectional view showing the positional relationship between the eccentric plate and the motor frame.

### DETAILED DESCRIPTION

An embodiment described herein is to provide a printer in which the amount of adjustment of the position where an engaging part and an engaged part engage with each other can be checked.

In general, according to at least one embodiment, a printer includes a first casing including a first engaged part, a second casing including a second engaged part, an engagement position adjustment mechanism, and an engagement position checker (an indicator). The engagement position adjustment mechanism is configured to adjust a first position of at least one of the first engaged part and the second engaged part to a second position, wherein the first engaged part and the second engaged part engage with each other at the second position. The engagement position checker can be configured to indicate the second position of the at least one the first engaged part and the second engaged part.

An embodiment to carry out the present disclosure will now be described with reference to the drawings. In the drawings, some configurations may be simplified or omitted in order to facilitate the understanding of the description. A thermal printer 1 according to an embodiment will now be described with reference to FIGS. 1 to 7.

FIG. 1 is a perspective view showing an external appearance of the thermal printer 1 according to the embodiment. FIG. 2 is a perspective view showing a state where the cover of the thermal printer 1 according to the embodiment is removed and in an open state. FIG. 3 is a side view showing the state where the cover of the thermal printer 1 according to the embodiment is removed and in a closed state.

As shown in FIGS. 1 to 3, the thermal printer 1 has a lower casing 2 and an upper casing 3. The lower casing 2 has a discharge port 21, a sheet attachment part 22, a hinge 23, a platen roller 24, a motor frame 25, and an engagement position adjustment mechanism 26 (e.g., engagement position adjuster) or the like. The upper casing 3 has a power button 31, an open button 32 (e.g., a button), a hook 33 (e.g., second engaged part), a ribbon cover 34, a roll attachment part 35, an operation and display panel 36, and a thermal head 37 or the like.

In the drawings, arrows indicating directions in relation to the thermal printer 1 are illustrated. An arrow X indicates a front-back direction. An arrow Y indicates a left-right direction. An arrow Z indicates an up-down direction. For example, in FIG. 1, the direction in which the discharge port 21 is situated is a front direction. The direction opposite to the front direction is a back direction. For example, in FIG. 1, the direction which intersects the front-back direction and in which the open button 32 is situated is a right direction. The direction opposite to the right direction is a left direction. The direction which intersects the front-back direction and the left-right direction and in which the upper casing 3 is situated is an up direction. The direction opposite to the up direction is a down direction.

The lower casing 2 is in a shape of a rectangular box open in the up direction. The lower casing 2 is coupled to the upper casing 3 via the hinge 23 provided in the back direction, as shown in FIG. 2. The lower casing 2 is an example of a first casing.

The power button 31 is provided at a wall in the front direction of the lower casing 2, as shown in FIG. 1. The power button 31 is a button to switch on and off the power of the thermal printer 1.

The discharge port 21 is provided between the lower casing 2 and the upper casing 3. The discharge port 21 is a slit through which a printed label sheet is discharged. The label sheet is an example of a print target medium.

The upper casing 3 is coupled to the lower casing 2 via the hinge 23 of the lower casing 2. The upper casing 3 is rotatably movable between a position in an open state shown in FIG. 2, where the inside of the thermal printer 1 is opened, and a position in a closed state shown in FIG. 3, where the inside of the thermal printer 1 is covered. The upper casing 3 is an example of a second casing.

The open button 32 is provided in the front direction of the upper casing 3, as shown in FIG. 1. The open button is a button to cause the hook 33 to operate in order to turn the upper casing 3 into the open state.

The hook 33 is provided to protrude in the down direction from the upper casing 3, as shown in FIG. 2. The hook 33 has a claw-like shape. When the thermal printer 1 is in the closed state, the hook 33 engages with a pin 262 (e.g., first engaged part), as described further herein, that is provided in the engagement position adjustment mechanism 26 of the lower casing 2, in such a way that the hook 33 catches the pin 262, and the hook 33 thus holds the closed state of the thermal printer 1. In response to a press on the open button 32, the hook 33 operates to disengage with the pin 262. The hook 33 is an example of an engaging part.

The ribbon cover 34 is provided in the front direction of the upper casing 3, as shown in FIG. 1. The ribbon cover 34 is rotatably movable about the back direction of the ribbon cover 34 as an axis of rotational movement. In the state where the ribbon cover 34 is opened, an ink ribbon can be attached to the roll attachment part 35, as described further herein, from the space between the ribbon cover 34 and the cover of the upper casing 3.

The roll attachment part 35 is provided in the upper casing 3, as shown in FIG. 3. To the roll attachment part 35, a supply roll (not illustrated) formed of a long ink ribbon wound in the shape of a roll, and a take-up roll (not illustrated) that takes up a used ink ribbon passing through the thermal head 37, are attached. The supply roll is attached more in the back direction of the thermal printer 1 than the take-up roll. The ink ribbon stretched between the supply roll and the take-up roll is conveyed in the state of being stacked on (e.g., above) the label sheet, between the thermal head 37 and the platen roller 24.

The operation and display panel 36 is provided in the front direction of the ribbon cover 34, as shown in FIG. 1. The operation and display panel 36 displays information about the thermal printer 1. The operation and display panel 36 accepts various operations about the thermal printer 1.

The sheet attachment part 22 is a shaft to attach a label sheet roll formed of a long label sheet wound in the shape of a roll. Each of the two ends of the sheet attachment part 22 is supported by a holder 221, as shown in FIG. 2. The holder 221 holds the attached label sheet. The holder 221 can be lifted (e.g., moved) in the up direction together with the sheet attachment part 22 and thus can be removed from the lower casing 2. The holder 221 removed from the lower casing 2 can be removed from the sheet attachment part 22. After one end of the sheet attachment part 22 is inserted in the hole of the label sheet roll and the one end of the sheet attachment part 22 is fixed by the holder 221, the label sheet together with the holder 221 is attached to the lower casing 2. Depending on the size of the direction of width (left-right direction) (e.g., a width) of the label sheet, a spacer may be attached to the sheet attachment part 22. The spacer limits the movement of the label sheet in the left-right direction.

The platen roller 24 is provided in the front direction of the lower casing 2, near the discharge port 21. The platen roller 24 provides a conveying force to draw out the label sheet from the label sheet roll. The platen roller 24 rotates in contact with the surface of the label sheet opposite to the surface on the side to be printed. The platen roller 24 is an example of a platen roller.

The thermal head 37 applies heat to the label sheet and prints thereon. The thermal head 37 is provided in the upper casing 3, as shown in FIG. 2. The thermal head 37 is arranged to face the platen roller 24 and is pressed toward the platen roller 24 when the thermal printer 1 is in the closed state. Since the platen roller 24 is pressed to the thermal head 37, the rotation of the platen roller 24 can provide a conveying force to the label sheet held between the platen roller 24 and the thermal head 37. The upper casing 3 has a pressing spring (not illustrated) that presses the thermal head 37 toward the platen roller 24. The thermal head 37 is an example of a thermal head.

The thermal head 37 provided in the thermal printer 1 according to the embodiment can print by the thermal transfer method and the thermal method.

The motor frame 25 is provided in such a way as to hold the platen roller 24 from both sides in the left-right direction, as shown in FIG. 2. The motor frame 25 has a motor 251 and a pulley 252, as shown in FIG. 3. The motor 251 is coupled to the platen roller 24 via the pulley 252 and provides a drive force to the platen roller 24. By rotating in the reverse direction, the motor 251 can cause the platen roller 24 to rotate in the reverse direction and can thus back-feed the label sheet. The motor frame 25 is an example of a frame.

The engagement position adjustment mechanism 26 is a mechanism that can adjust the position of the pin 262 in relation to the lower casing 2 in the up-down direction. The engagement position adjustment mechanism 26 is a mechanism that can adjust the position where the hook 33 of the upper casing 3 and the pin 262 provided in the engagement position adjustment mechanism 26 of the lower casing 2 engage with each other when the thermal printer 1 is in the closed state. Hereinafter, the adjustment of the position of the pin 262 corresponds to the adjustment of the position where the hook 33 and the pin 262 engage with each other. For example, the pin 262 is adjusted from a first position to a second position to engage with the hook 33. The engagement position (e.g., the second position) is the position where the hook 33 and the pin 262 are structured to engage with each other.

The engagement position adjustment mechanism 26 will now be described in detail with reference to FIGS. 4 to 7. FIG. 4 is a schematic view showing a state where the hook 33 and the pin 262 in the thermal printer 1 according to the embodiment are engaged with each other. The engagement position adjustment mechanism 26 has an engagement position adjustment plate 261, the pin 262, a fulcrum 263, a support member 264, and an eccentric plate 266.

The engagement position adjustment plate 261 is provided with the pin 262, the fulcrum 263, a sensor 265 via the support member 264, and the eccentric plate 266. The engagement position adjustment plate 261 is retained to the motor frame 25 by a retaining member 2611 and a retaining member 2612. The motor frame 25 and the engagement position adjustment plate 261 are provided with insertion holes (not illustrated) to insert the retaining member 2611 and the retaining member 2612. The insertion holes in the engagement position adjustment plate 261 are provided with a margin in the up-down direction, compared with the diameter of the inserted parts of the retaining member 2611 and the retaining member 2612. The engagement position adjustment plate 261 is installed on both sides in the left-right direction of the thermal printer 1.

The pin 262 is engaged with the hook 33 when the thermal printer 1 is in the closed state. The pin 262 is arranged (e.g., located) more in the back direction (to the rear) of the thermal printer 1 than the fulcrum 263 and has a cylindrical shape extending outward in the left-right direction of the thermal printer 1. The pin 262 is an example of an engaged part.

The fulcrum 263 is provided at a position in the down direction of the platen roller 24, on the engagement position adjustment plate 261. The engagement position adjustment plate 261 rotationally moves about the fulcrum 263 in an x-direction and a B-direction, within the margin in the up-down direction of the insertion holes in the engagement position adjustment plate 261 with which the inserted parts of the retaining member 2611 and the retaining member 2612 interfere. With the rotational movement of the engagement position adjustment plate 261, the pin 262, the support member 264, and the eccentric plate 266 rotationally move about the fulcrum 263.

As the engagement position adjustment plate 261 is rotationally moved in the direction of the arrow α shown in FIG. 4, the position of the pin 262 moves relatively in the down direction and the engagement position is adjusted in the down direction. As the engagement position drops, the upper casing 3, to which the hook 33 is coupled, is moved more in the down direction than before the adjustment of the engagement position, and the pressure of the thermal head 37 increases than before the adjustment of the engagement position.

As the engagement position adjustment plate 261 is rotationally moved in the direction of the arrow β shown in FIG. 4, the position of the pin 262 moves in the up direction and the engagement position is also adjusted in the up direction. As the engagement position is adjusted in the up direction, the upper casing 3, to which the hook 33 is coupled, is moved more in the up direction than before the adjustment of the engagement position, and the pressure of the thermal head 37 decreases than before the adjustment of the engagement position.

Since the engagement position adjustment plate 261 is provided on the left and right sides of the thermal printer 1, for example, if the engagement position on the left side is adjusted downward, the pressure on the left side in the longitudinal direction of the thermal head 37 increases. If the engagement position on the right side of the thermal printer 1 is adjusted downward, the pressure applied on the right side in the longitudinal direction of the thermal head 37 increases.

The support member 264 is retained to the engagement position adjustment plate 261 by a retaining member 2641. The support member 264 is provided more to the back side than the pin 262 and more to the front side than the eccentric plate 266. The support member 264 is a plate-like member in a shape twisted 90 degrees near the middle part thereof, and is provided with the sensor 265 at the lower end thereof. The support member 264 has a ruled line 2642 near the eccentric plate 266. The ruled line 2642 is an indicator to read a scale mark 2662, described later.

The sensor 265 is an optical sensor that detects whether the thermal printer 1 is in the open state or in the closed state. The sensor 265 is provided at the engagement position adjustment plate 261 via the support member 264. The sensor 265 is, for example, rectangular shaped and an infrared ray passes through the sensor 265 along the left-right direction. The sensor 265 is provided at such a position that the hook 33 blocks the infrared ray when the thermal printer 1 is in the closed state and that the hook 33 does not block the infrared ray when the thermal printer 1 is in the open state. In the state where the hook 33 blocks the infrared ray, the sensor 265 detects that the thermal printer 1 is in the closed state. In the state where the hook 33 does not block the infrared ray, the sensor 265 detects that the thermal printer 1 is in the open state.

The eccentric plate 266 is a member that enables checking of the amount of adjustment of the engagement position (e.g., between the first position and the second position). The eccentric plate 266 has an eccentric circular shape and is retained to the engagement position adjustment plate 261 by a retaining member 2661. The eccentric plate 266 is provided to be rotatable about the retaining member 2661. The eccentric plate 266 is provided more to the back side than the support member 264. The eccentric plate 266 is provided in such a way that a part of the circumference of the eccentric plate 266 protrudes from the edge in the up direction of the engagement position adjustment plate 261. The eccentric plate 266 is manually rotated, for example, by a user. The eccentric plate 266 is an example of an engagement position checking member.

The retaining member 2661 is a screw. When the retaining member 2661 is tightened, the eccentric plate 266 is held between the head of the retaining member 2661 and the engagement position adjustment plate 261, and the eccentric plate 266 is fixed by the frictional force between the head of the retaining member 2661 and the engagement position adjustment plate 261. Meanwhile, when the retaining member 2661 is loosened, the head of the retaining member 2661 moves in the direction away from the engagement position adjustment plate 261, and the frictional force between the head of the retaining member 2661 and the engagement position adjustment plate 261 applied to the eccentric plate 266 decreases. Thus, the eccentric plate 266 can be rotated.

FIG. 5 shows the positional relationship between the engagement position adjustment plate 261 and the motor frame 25. As shown in FIG. 5, the edge in the up direction of the motor frame 25 has a shape extending toward the left-right direction of the thermal printer 1, and is in the shape of an eave. Hereinafter, the eave-shaped edge of the motor frame 25 is referred to as an eave part 253 (an extended part). The engagement position adjustment plate 261 is provided at a position under the eave, which is a position in the down direction of the eave part 253. The eccentric plate 266 is provided at a position under the eave and is not provided at a position protruding in the left-right direction from the eave. At the eave part 253, an insertion hole 331, which is a hole in which the hook 33 is inserted, is provided in the up direction of the pin 262.

FIGS. 6 and 7 show the positional relationship between the eccentric plate 266 and the motor frame 25. FIGS. 6 and 7 show a state where the engagement position adjustment plate 261 is rotationally moved in the direction of the arrow α shown in FIG. 4.

As shown in FIGS. 6 and 7, a part near the circumference of the eccentric plate 266 is partitioned by ruled lines and numbers “1”, “2”, “3”, “4”, “5” are given in the partitioned parts. Hereinafter, the numbers partitioned by the ruled lines are referred to as the scale mark 2662. In the embodiment, the distance from the circumference of the eccentric plate 266 to the center of rotation, that is, the distance from the circumference of the eccentric plate 266 to the retaining member 2661, is designated to gradually increase over the part from “1” to “5” of the scale mark 2662. Also, the support member 264 with the ruled line 2642 formed thereon is arranged near the eccentric plate 266. With the ruled line 2642 on the support member 264 and the scale mark 2662 formed on the eccentric plate 266, the user can quantitatively grasp the current engagement position in the thermal printer 1. The scale mark 2662 on the eccentric plate 266 shown in FIGS. 4, 6, and 7 is one example. For example, more ruled lines may be provided on the eccentric plate 266 to enable more detailed reading of the engagement position.

A method for checking the engagement position using the eccentric plate 266 will now be described. First, the retaining member 2611 and the retaining member 2612 are loosened to enable the engagement position adjustment plate 261 to rotationally move. If the engagement position adjustment plate 261 rotationally moves in the direction of the arrow α, the eccentric plate 266 moves to a position away from the eave part 253 of the motor frame 25, as shown in FIG. 6, with the rotational movement of the engagement position adjustment plate 261. The retaining member 2611 and the retaining member 2612 are tightened to retain (e. g., hold) the engagement position adjustment plate 261. The retaining member 2661 is loosened, and the eccentric plate 266 is rotated until the circumference of the eccentric plate 266 abuts on (e.g., contacts) the eave part 253 of the motor frame 25, as shown in FIG. 7. The retaining member 2661 is tightened again. Subsequently, the current engagement position is checked, using the scale mark 2662 on the eccentric plate 266 and the ruled line 2642 on the support member 264. For example, in FIG. 7, the current engagement position can be read as “4”. With the above procedures, the current engagement position be quantitatively checked. The above procedures of the method for checking the engagement position using the eccentric plate 266 are one example, and the series of procedures may be freely changed in order.

The eccentric plate 266 abuts on the eave part 253 after the adjustment of the engagement position. Therefore, if the engagement position is adjusted in the down direction despite no need to adjust the engagement position, the engagement position can be returned to the position before the adjustment. Also, since the eccentric plate 266 abuts on the eave part 253 after the adjustment of the engagement position, the engagement position can be mitigated or prevented from being adjusted in the up direction despite no need to adjust the engagement position.

As described above, the eccentric plate 266 is such a member that the position of the circumference of the eccentric plate 266 in contact with (e.g., contact point) the eave part 253 changes according to the engagement position between the hook 33 and the pin 262. The eccentric plate 266 is a member indicating the engagement position representing the position where the pin 262 and the hook 33 engage with each other, adjusted by the engagement position adjustment mechanism.

The positions where the hook 33 and the pin 262 are provided are not limited to the upper casing 3 and the lower casing 2. If the hook 33 is provided in the lower casing 2, the pin 262 may be provided in the upper casing 3.

The position where the engagement position adjustment mechanism 26 is provided is not limited to the motor frame 25. For example, the engagement position adjustment mechanism 26 may be provided in the upper casing 3.

In the embodiment, the thermal printer 1 in which the thermal head 37 and the platen roller 24 are in contact with each other in the up-down direction is described. However, the present technique can also be used for a thermal printer in which the thermal head 37 and the platen roller 24 are in contact with each other in the front-back direction.

While certain embodiments have been described, these embodiments have been presented by way of example only, and are not intended to limit the scope of the disclosure. Indeed, these embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A printer comprising:
a first casing comprising a first engaged part;
a second casing comprising a second engaged part to engage with the first engaged part;
an engagement position adjustment mechanism configured to adjust a first position of at least one of the first engaged part and the second engaged part to a second position, the first engaged part and the second engaged part structured to engage with each other at the second position; and
an engagement position indicator configured to indicate the second position of the at least one the first engaged part and the second engaged part.

2. The printer according to claim 1, further comprising:
a frame, wherein
the engagement position adjustment mechanism is provided at the frame, and
a contact point between a circumference of the engagement position indicator and the frame changes according to the second position.

3. The printer according to claim 1, wherein
the engagement position indicator comprises a scale mark indicating the second position.

4. The printer according to claim 1, wherein
the first casing comprises a thermal head,
the second casing comprises a platen roller, and
the thermal head and the platen roller are in contact with each other when the first casing and the second casing are in a closed state.

5. The printer according to claim 2, wherein
the engagement position indicator is provided at a third position under an extended part of the frame.

6. The printer according to claim 1, wherein
the first engaged part is a pin and the second engaged part is a hook.

7. The printer according to claim 1, wherein
the engagement position indicator comprises an eccentric plate.

8. A printer comprising:
a lower casing comprising a pin;
an upper casing comprising a hook;
an engagement position adjustment mechanism to adjust the printer between an open state and a closed state, the engagement position adjustment mechanism to adjust at least one of the pin or the hook from a first position to a second position, the pin engaging with the hook at the second position, and the printer in the closed state at the second position; and
an engagement position indicator to indicate the second position.

9. The printer according to claim 8, wherein the engagement position indicator comprises an eccentric plate comprising ruled lines to indicate the second position.

10. The printer according to claim 8, further comprising a button, the pin to disengage with the hook in response to pressing of the button.

11. The printer according to claim 8, wherein
the lower casing comprises a thermal head,
the upper casing comprises a platen roller, and
the thermal head and the platen roller are in contact with each other when the lower casing and the upper casing are in a closed state.

12. The printer according to claim 8, further comprising:
a frame, wherein
the engagement position adjustment mechanism is provided at the frame, and
a contact point between a circumference of the engagement position indicator and the frame changes according to the second position.
